(19) United States
(12) Patent Application Publication
(10) Pub. No.: US 2022/0290667 A1
(43) Pub. Date: Sep. 15, 2022

(54) PORTABLE FLUID PUMP

(71) Applicant: ENTIRE R&D PTY LTD, FORRESTDALE (AU)

(72) Inventors: Michael FANCOTE, FORRESTDALE (AU); Gavin FANCOTE, FORRESTDALE (AU)

(21) Appl. No.: 17/634,093

(22) PCT Filed: Aug. 10, 2020
(86) PCT No.: PCT/AU2020/000079

§ 371 Date: Feb. 9, 2022

(30) Foreign Application Priority Data
Aug. 12, 2019 (AU) 2019902906

(51) Int. Cl. F04C 15/06; F04C 14/08; A62C 27/00; A62C 3/02; F04C 2/107

(52) U.S. Cl. CPC F04C 15/064; F04C 14/08; A62C 27/00; A62C 3/0292; F04C 2/1071; F04C 2270/205; F04C 2240/20; F04C 2270/185; F04C 2240/81

(57) ABSTRACT

A portable fluid pump comprises a tank, a positive displacement pump comprising a fluid inlet and outlet, and an electric motor that drives the positive displacement pump, wherein the electric motor is a brushless variable speed electric motor operating at 110 volts or less. A conduit diverts fluid pumped by the positive displacement pump back into the tank and an actuated valve assembly controls fluid flow through the conduit and, therefore, a pressure of fluid flow through the fluid outlet. A pair of sensors measure, respectively, a pressure and a flow rate of fluid flow through the fluid outlet. A system controller receives a target fluid pressure and fluid flow rate and adjusts a throttle position of the actuated valve assembly and a speed of the electric motor such that pressure and flow rate readings from the sensors substantially match, respectively, the target fluid pressure and fluid flow rate.

### FIELD

The present invention relates to pumping systems and, more particularly, to a portable fluid pump that is mountable onto vehicles and trailers.

### BACKGROUND

Portable fluid pumps typically comprise some form of centrifugal pump that is connected to a fluid storage tank. The pump is commonly powered by an internal combustion engine and operates to draw fluid from the tank into a fluid inlet of the pump. Fluid is expelled from the pump under pressure via a fluid outlet that is connectable to one or more fluid carrying conduits. For example, portable pump systems that are used for fire fighting typically comprise a centrifugal pump that is mounted onto the back of a utility vehicle or trailer. The pump may be powered by its own diesel engine or by a drive belt connected to a drive pulley wheel provided on the vehicle's engine. One or more hoselines or manually operated hose reels may be connected to the pump's fluid outlet.

Centrifugal pump and engine combinations are limited in their ability to deliver a flexible range of water volumes and pressures to the operator. In particular, fluid flow rate and pressure are coupled together in such systems which means that decreasing the engine speed results in a reduction in both flow rate and pressure. Similarly, increasing the engine speed results in an increase in both flow rate and pressure which may not be ideal for the operator. For example, when portable fire fighting pump systems are being used to extinguish burning peat on bushland, a high water pressure is required to ensure that the water sprayed from the connected hoseline penetrates deep into the peat. A centrifugal pump is only able to produce a high fluid pressure by working at a fast rotational speed. This, in turn, results in a high fluid flow rate which causes the reserve of water stored in the pump's tank to be depleted too rapidly.

Petrol and diesel engines are also noisy to operate and can exceed acceptable noise thresholds, particularly when operating at medium-to-high speeds. Centrifugal pumps are also susceptible to air locks during use if adequate fluid levels are not maintained inside of the pump and in its fluid supply conduits. If the pump runs out of available fluid, then it will normally require some form of fluid priming to reinstate its pumping capability. In firefighting applications, draughting of water from an open water source requires the pump to be primed with water before the pump can draw water into the tank. This pump is primed typically using either a manually operated priming valve or using an electrically operated priming pump. These devices are time consuming and impractical to use, especially if the pump needs to be used in an emergency situation.

When an engine is used to drive a vehicle-mounted fluid pump, the engine requires either an inbuilt fuel tank or a fuel line connected to the vehicle's fuel tank. An additional store of fuel for the engine also often needs to be kept on the pump or vehicle for refueling purposes. The fuel that is used is typically unleaded petrol which is highly flammable, volatile and susceptible to temperature changes. When a drive belt is used to drive a vehicle-mounted fluid pump, this configuration requires the vehicle's engine to be constantly running during use. The drive belt is also typically provided on the exterior of the vehicle and pump housing and is, therefore, vulnerable to damage when exposed to fire and other hazardous conditions.

In this context, there is a need for improved portable fluid pumps.

### SUMMARY

According to the present invention, there is provided a portable fluid pump adapted to be mounted onto a vehicle or trailer, the portable fluid pump comprising:
a tank for storing fluid;
a positive displacement pump comprising a fluid inlet fluidly connected to the tank and a fluid outlet;
at least one electric motor that operatively drives the positive displacement pump to pump fluid received from the fluid inlet into the fluid outlet, wherein the electric motor is a brushless variable speed electric motor configured to operate at 110 volts or less;
a conduit arranged to divert fluid pumped by the positive displacement pump back into the tank, wherein the conduit is provided with an actuated valve assembly that controls fluid flow through the conduit and, therefore, a pressure of fluid flow through the fluid outlet;
a pair of sensors configured to measure, respectively, a pressure and a flow rate of fluid flow through the fluid outlet;
a system controller operatively connected to the electric motor, the actuated valve assembly and the sensors, wherein the system controller is configured to:
   receive a target fluid pressure and a target fluid flow rate from a control device operatively connected to the system controller; and
   adjust a throttle position of the actuated valve assembly and a rotational speed of the electric motor such that pressure and flow rate readings received by the system controller from the sensors substantially match, respectively, the target fluid pressure and the target fluid flow rate.

The portable fluid pump may comprise an outlet pump housing that receives pressurised fluid from the positive displacement pump, wherein the outlet pump housing comprises the fluid outlet and a second fluid outlet, the conduit being fluidly connected to the second fluid outlet.

The portable fluid pump may comprise a fluid line connected to the fluid outlet, wherein the conduit is fluidly connected to the fluid line.

The system controller may execute a proportional-integral-derivative control loop to adjust the throttle position of the actuated valve assembly and the rotational speed of the electric motor.

A throttle of the actuated valve assembly may be controlled by a solenoid actuator.

The actuated valve assembly may comprise a butterfly valve.

The electric motor may be a permanent magnet DC electric motor.

The electric motor may comprise a gearing mechanism to increase an output torque of the electric motor.

The positive displacement pump may be operatively driven by a drive belt, wherein the drive belt is connected to a drive pulley wheel axially connected to a drive shaft of the electric motor and to a driven pulley wheel axially connected to a drive shaft of the positive displacement pump, wherein a diameter of the drive pulley wheel is less than a diameter of the driven pulley wheel.

The portable fluid pump may comprise a plurality of electric motors that drive the drive belt.

The portable fluid pump may comprise an idler pulley wheel that engages the drive belt and a biaser mechanism configured to cause the idler pulley wheel to exert a force on the drive belt to maintain tension in the drive belt.

The plurality of electric motors may be operatively connected to the driven pulley wheel by a pair of drive belts.

The positive displacement pump may comprise a helical rotor pump.

The portable fluid pump may further comprise one or more batteries for supplying an electric current to the electric motor, wherein the batteries are electrically connectable to an external power source to charge the batteries.

The portable fluid pump may further comprise a step-up transformer connected between the batteries and the electric motor for increasing a voltage of the electric current.

The portable fluid pump may further comprise:
a deluge system comprising one or more fluid dispensers fluidly connected to the fluid outlet for spraying fluid over the portable fluid pump; and
a valve assembly configured to control fluid flow from the fluid outlet to the deluge system.

The fluid inlet of the positive displacement pump may be connectable to an external fluid source separate to the tank.

The tank may further comprise a fluid inlet connectable to an external fluid source separate to the tank.

The system controller may be provided with a storage device to store a plurality of system configurations, wherein the system controller is configured to:
receive a selected of the system configurations from the control device;
determine a preset fluid pressure and a preset fluid flow rate associated with the selected of the system configurations; and
adjust a throttle position of the actuated valve assembly and a rotational speed of the electric motor such that pressure and flow rate readings received by the system controller from the sensors substantially match, respectively, the preset fluid pressure and the preset fluid flow rate.

The portable fluid pump may comprise a firefighting hoseline attached to the fluid outlet of the positive displacement pump, wherein the control device is attached to a handheld firefighting nozzle at an end of the firefighting hoseline.

### BRIEF DESCRIPTION OF DRAWINGS

Embodiments of the invention will now be described by way of example only with reference to the accompanying drawings, in which:

FIG. 1 is a schematic diagram of a portable fluid pump adapted to be mounted onto a vehicle or trailer according to an example embodiment of the invention;

FIG. 2 is a side elevation of the portable fluid pump mounted on a firefighting utility vehicle;

FIG. 3A is a cross sectional plan view of a positive displacement pump and drive assembly comprised in the portable fluid pump;

FIG. 3B is a side elevation of the positive displacement pump and drive assembly;

FIG. 3C is a rear elevation of the positive displacement pump and drive assembly; and

FIG. 4 is an exploded isometric view of internal components included in the positive displacement pump and drive assembly.

### DESCRIPTION OF EMBODIMENTS

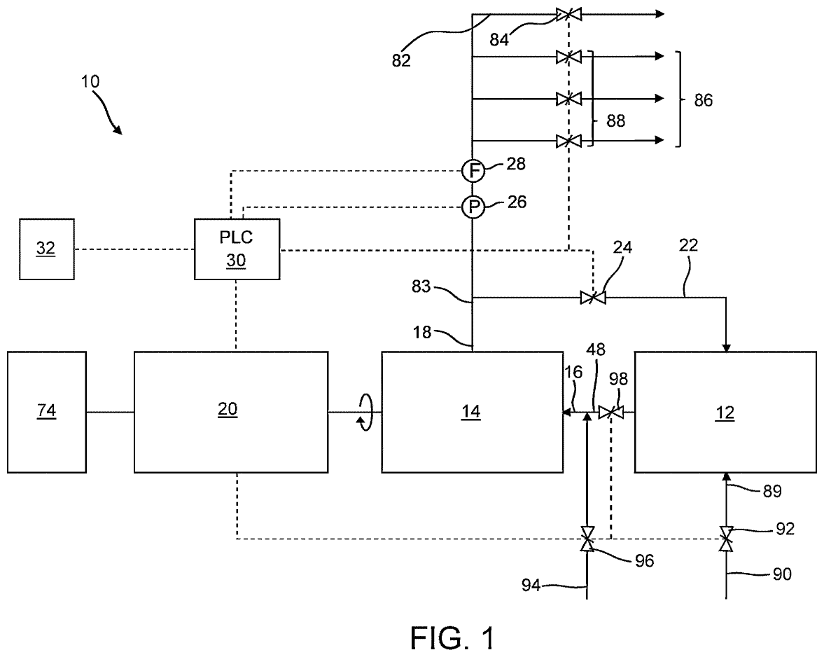

Referring to FIG. 1, an example embodiment of the present invention provides a portable fluid pump 10 that is adapted to be mounted onto a vehicle or trailer. The portable fluid pump 10 comprises a tank 12 for storing fluid and a positive displacement pump 14 comprising a fluid inlet 16 fluidly connected to the tank 12 and a fluid outlet 18. At least one electric motor 20 operatively drives the positive displacement pump 14 to pump fluid received from the fluid inlet 16 into the fluid outlet 18, wherein the electric motor 20 is a brushless variable speed electric motor configured to operate at 110 volts or less. The portable fluid pump 10 also comprises a conduit 22 that is arranged to divert fluid pumped by the positive displacement pump back into the tank 12, wherein the conduit 22 is provided with an actuated valve assembly 24 that controls fluid flow through the conduit 22 and, therefore, a pressure of fluid flow through the fluid outlet 18. A pair of sensors 26, 28 are configured to measure, respectively, a pressure and a flow rate of fluid flow through the fluid outlet 18. The portable fluid pump 10 also comprises a system controller 30 operatively connected to the electric motor 20, the actuated valve assembly 24 and the sensors 26, 28. The system controller 30 is configured to receive a target fluid pressure and a target fluid flow rate from a control device 32 operatively connected to the system controller 30 and to adjust a throttle position of the actuated valve assembly 24 and a rotational speed of the electric motor 20 such that pressure and flow rate readings received by the system controller 30 from the sensors 26, 28 substantially match, respectively, the target fluid pressure and the target fluid flow rate.

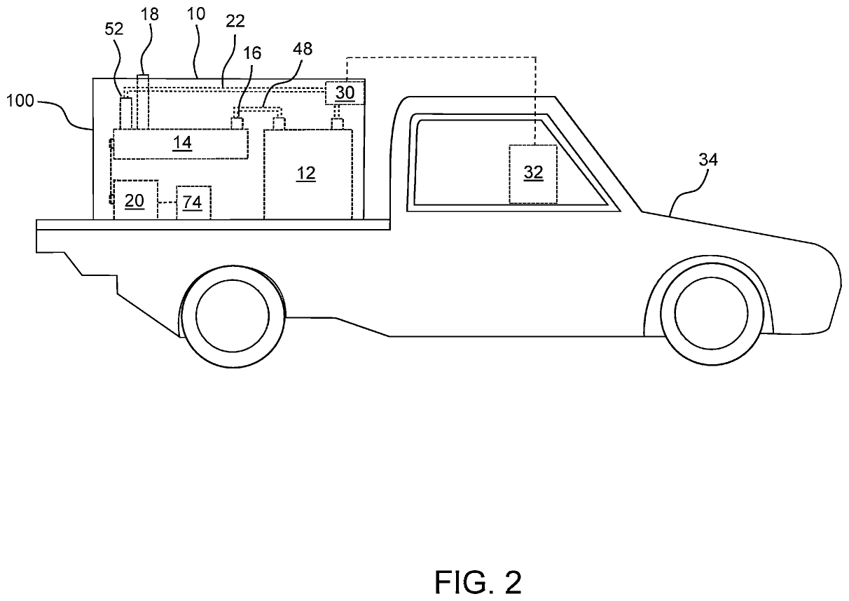

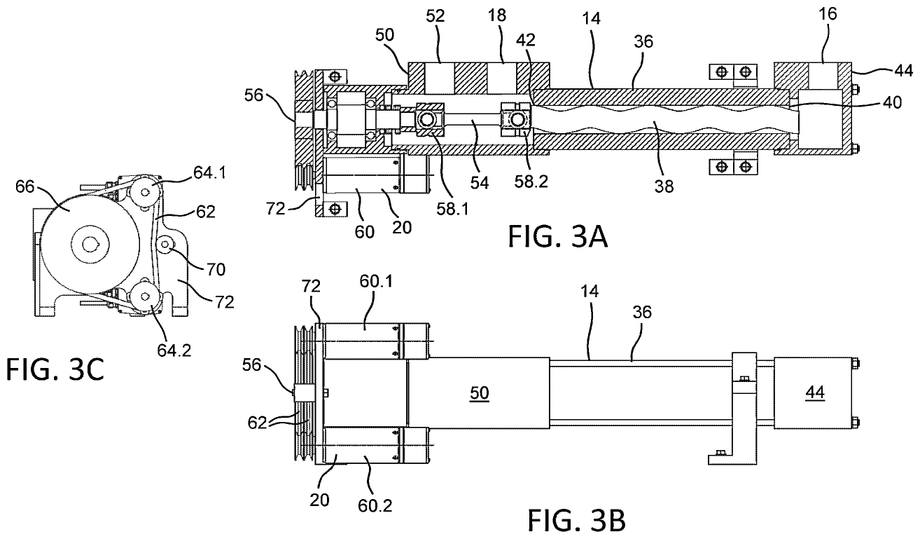

The portable fluid pump 10 is mountable onto a range of different vehicles and trailers. For example, referring to FIG. 2 the portable fluid pump 10 may be mounted into the back of a utility vehicle 34 used for fire fighting and the fluid outlet 18 may be connectable to a firefighting hoseline. Referring to FIG. 3A, the positive displacement pump 14 may comprise a helical rotor pump that comprises a hollow elongate stator 36 with an internal cylindrical cavity containing a screw 38. The screw 38 rotates about its longitudinal axis in use and operates to propel fluid along the axis through the internal cavity from an inlet end 40 towards an outlet end 42 of the stator 36. A first (inlet) pump housing 44 may be provided at the inlet end 40 of the stator 36 that comprises the fluid inlet 16. The fluid inlet 16 feeds into an internal chamber of the inlet pump housing 44 that fluidly interfaces with the inlet end 40. A conduit 48 may be attached to the fluid inlet 16 which supplies fluid from the tank 12 to the positive displacement pump 14. The tank 12 may contain water or a similar firefighting fluid.

A second (outlet) pump housing 50 may be provided at the outlet end 42 of the stator 36. The outlet pump housing 50 may comprise an internal chamber that receives pressurised fluid from the outlet end 42 and the first fluid outlet 18 that receives the pressurised fluid from the internal chamber. The outlet pump housing 50 may also comprise a second fluid outlet 52 which the conduit 22 may be attached to in order to provide a pressure control system for the pump 14.

A rotatable knuckle joint 54 may be provided inside of the outlet pump housing 50 between the screw 38 and a drive shaft 56 of the positive displacement pump 14. The knuckle joint 54 is rotatable about its longitudinal axis and transfers rotational motion from the drive shaft 56 to the screw 38. The knuckle joint 54 may comprise a pair of connectors 58 at opposed ends of its axis. The second of the connectors 58.2, that is proximal to the end of the screw 38 at the outlet end 42 of the stator 36, may be shaped and positioned such that its rotational path is offset from the rotational axis of the knuckle joint 54. In this configuration, the rotational path of the second connector 58.2 is aligned and matched with the rotational path followed by the end of the screw 38 that it is connected to during use. This ensures that the rotational motion of the drive shaft 56 and knuckle joint 54 is transferred to the screw 38 effectively.

The portable fluid pump 10 may be powered by a drive assembly that comprises a plurality of electric motors to increase the maximum available torque applied to the drive shaft 56. In the example depicted, the portable fluid pump 10 comprises a pair of electric motors 60.1, 60.2 arranged in vertical alignment next to the drive shaft 56. The motors 60.1, 60.2 may be operatively connected to the drive shaft 56 via a pair of drive belts 62 that are arranged parallel to one another. Two drive belts 62 are used in order to provide for redundancy should one of them get damaged or fail to operate during use. The belts 62 may comprise rubber-based double V-belts and may extend around a pair of small drive pulley wheels 64 connected to the respective axles of the motors 60.1, 60.2 and around a larger driven pulley wheel 66 connected to the axle of the drive shaft 56. As shown in FIG. 3C, the diameters of the drive pulley wheels 64 may be smaller than the diameter of the driven pulley wheel 66 to amplify the torque applied by the motors 60.1, 60.2 to the drive shaft 56.

The portable fluid pump 10 may also comprise a belt tensioner comprising an idler pulley wheel 70 that remains in abuting contact with the drive belts 62 during use. The idler pulley wheel 70 may be attached to a rearward-disposed face plate 72 of the positive displacement pump 14 using a biaser mechanism that causes the pulley wheel 70 to exert a constant inwards force on the drive belts 62 to maintain tension in the drive belts 62.

The electric motors 60.1, 60.2 preferably comprise low-voltage variable speed motors fitted with gearboxes that have the necessary torque, power curve and energy consumption properties to operate the positive displacement pump 14 effectively. In one example, the electric motors 60.1, 60.2 may deliver sufficient power such that the positive displacement pump 14 may operate at up to 1500 rpm and may pump up to 275 litres of fluid per minute at 12 bar of pressure. The electric motors 60.1, 60.2 may comprise brushless motors, such as brushless DC permanent magnet electric motors, which deliver the required torque to turn the drive shaft 56 of the positive displacement pump 14. Importantly, the electric motors 60.1, 60.2 are configured to operate at 110 volts or less. This operational voltage substantially removes the risk of electric shock to users of the portable fluid pump 10 when it is being used in environments and conditions where water can readily come into contact with the housing of the portable fluid pump 10, such as in firefighting.

In one example, the electric motors 60.1, 60.2 may be operable when supplied with 48 volts of electricity. This configuration advantageously enables the motors 60.1, 60.2 to be connected to, and powered by, standard car batteries provided on the vehicle 34. In the example depicted, the motors 60.1, 60.2 are powered by a battery pack 74 that may comprise two 12 volt batteries wired in series to generate a total electric potential of 24 volts. A step-up transformer (not shown) may be connected between the battery pack 74 and electric motors 60.1, 60.2 to increase the total voltage from 24 volts to 48 volts. The battery pack 74 may be electrically connectable to an external power source to charge the batteries. For example, the battery pack 74 may be electrically connectable to an alternator of the vehicle 34. The portable fluid pump 10 may also comprise one or more lights (not shown) attached to the portable fluid pump 10 that are powered by the battery pack 74.

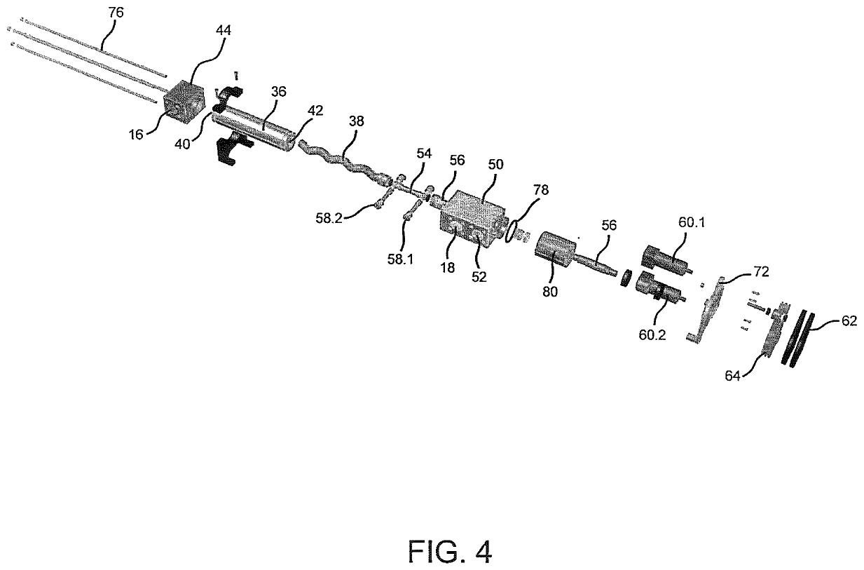

Referring to FIG. 4, the positive displacement pump 14 may comprise four elongate rods 76 that extend through, and connect together, various internal components of the pump 14. In particular, the rods 76 extend through the inlet and outlet housings 44, 50 of the screw pump stator 36 to fasten the housings to the face plate 72. A rubber O-ring 78 and cylindrical drive bearing housing 80 may be used to provide a watertight and effective connection between the drive shaft 56 and the rotatable knuckle joint 54. To minimize weight, the inlet and outlet housings 44, 50 and the drive bearing housing 80 may be made of an aluminium alloy.

As shown by the hydraulic circuit included in FIG. 1, the portable fluid pump 10 comprises a conduit 22 that returns a proportion of the fluid pumped by the positive displacement pump 14 back into the tank 12. Redirecting some of the pumped fluid back into the tank 12 causes the resultant pressure of the fluid flowing through the fluid outlet 18 to be reduced. The actuated valve assembly 24 operates as a pressure sustaining valve to control the proportion of fluid flowing through the return conduit 22 back to the tank 12. By varying this proportion, the valve assembly 24 consequently controls the pressure of the fluid flowing through the fluid outlet 18 into the connected firefighting hoseline.

A hose reel (not shown) may be attached to the portable fluid pump 10 that comprises a rotatable drum sufficiently large such that up to 100 metres of 19 mm rubber firefighting hose may be wound around the drum. The hose reel may be operated by an electric motor capable of rotating the drum in clockwise and anticlockwise directions. The hose reel may be configured with self-wrapping and winding capabilities such that the hose may be conveniently stored when not in use and extracted as needed.

The firefighting hoseline may be connected to the positive displacement pump 14 via a hose conduit 82 that extends from the hose reel to the first fluid outlet 18. In the hydraulic circuit diagram provided in FIG. 1, for simplicity both the hose conduit 82 and the return conduit 22 and shown connected to the positive displacement pump 14 via a single, shared fluid line 83 that is connected to the first fluid outlet 18. However, it will be appreciated that the conduits 82, 22 may be fluidly connected to, respectively, the first fluid outlet 18 and the second fluid outlet 52 of the outlet housing 50 of the positive displacement pump 14. An actuated flow control valve 84 may control the flow of fluid through the hose conduit 82.

The portable fluid pump 10 may comprise various additional adapters, couplings and conduits that allow fluid to be pumped from the positive displacement pump 14 to other firefighting equipment that may be provided with, or attached to, the portable fluid pump 10. For example, the portable fluid pump 10 may comprise three additional conduits 86 that may carry fluid from the first fluid outlet 18 to, respectively, (i) a deck hose, (ii) a deluge system and (iii) a hydraulic coupling device such as a BIC (British Instantaneous Coupling) outlet. Three actuated flow control valves 88 may be used to control the flow of fluid through the three conduits 86 on a variable basis.

The deluge system of the portable fluid pump 10 may comprise one or more fluid dispensers, such as sprinklers, that can be switched on to spray fluid over the portable fluid pump 10 should an approaching fire threaten the safety of the portable fluid pump 10 and its operators during use.

The tank 12 may comprise an inlet 89 that is connectable to a pressurised fluid source external to the portable fluid pump 10 to replenish the tank 14 during use. For example, the inlet 89 may be connectable to a reticulated water system or hydrant standpipe. A conduit 90 comprising an actuated flow control valve 92 may control the flow of fluid into the inlet 89 from the external fluid source. A further conduit 94 and actuated flow control valve 96 may be fluidly connected to the fluid inlet 16 of the positive displacement pump 14. The conduit 94 and valve 96 enable fluid to be sucked into positive displacement pump 14 on a controlled basis from a non-pressurised fluid source external to the portable fluid pump 10 during use, such as from a stream, river, dam or similar open water course. The system 10 may also comprise a further flow control valve 98 provided on the conduit 48 that controls the flow of fluid from the tank 12 to the positive displacement pump 14. The various actuated valve assemblies 24, 84, 88, 92, 96, 98 used in the portable fluid pump 10 may comprise butterfly-type throttle valves each having a pressure rating of up to 16 bar. The throttle valves may be actuated using electric solenoid actuators controlled by the system controller 30.

As depicted in FIG. 1, the portable fluid pump 10 comprises a system controller 30 that is configured to control various operational components of the portable fluid pump 10. In particular, the system controller 30 controls the rotational speed(s) of the electric motor(s) 20 to thereby control a flow rate (and, therefore, velocity) of fluid pumped by the positive displacement pump 14 through the fluid outlet 18. In one example, the system controller 30 may be configured to increase or decrease the flow rate of the pump 14 selectively in 25 litre-per-minute increments within an operating range of 25 to 275 litres per minute (inclusive). The system controller 30 varies the electric motor speed(s) until the flow rate measured by the flow sensor 28 matches the desired (target) flow rate selected using the control device 32.

The system controller 30 also controls the throttle position of the actuated valve assembly 24 to thereby vary the resultant pressure of the fluid pumped by the positive displacement pump 14 through the fluid outlet 18. In one example, the system controller 30 may be configured such that the pressure may be increased or decreased selectively in 1 bar increments within an operating range of 1 to 12 bar (inclusive). The system controller 30 varies the throttle position of the actuated valve assembly 24 until the pressure measured by the pressure sensor 26 matches the desired (target) pressure selected using the control device 32.

The system controller 30 may execute a proportional-integral-derivative (PID) control loop to adjust the throttle position and electric motor speed(s). The PID control loop may continuously calculate error values as the differences between the relevant target pressure and target flow rate (being the setpoints of the control loop) and the measured pressure and flow rate received from the sensors 26, 28 and apply corrections to the throttle position and electric motor speed(s) accordingly based on proportional, integral and derivative terms.

The portable fluid pump 10 may be provided with a control panel and/or a remote control device 32 in wired or wireless communication with the system controller 30 that allows the target fluid pressure and target flow rate to be set by a user of the pump 10 remotely. In one example, the control device 32 may comprise a control panel featuring touch-type buttons, switches, dials and other user-interface devices. In the example depicted in FIG. 2, the control device 32 is wirelessly connected to the system controller 30 and is shown located in the cabin of the firefighting vehicle 34. The control device 32 may be portable and operated inside or outside the cabin. In other examples, the control device 32 may be attached to, or proximal to, a handheld firefighting nozzle provided at the end of the firefighting hoseline connected to the fluid outlet 18. In this arrangement, the target pressure and flow rate can be conveniently set and modified by the user when holding and operating the nozzle during use. The control device 32 may also receive data from the system controller 30 about various operational conditions of the pump 10 during use. For example, the control device 32 may receive data representing the level of fluid remaining in the tank 12 and/or the current pressure and flow rate of fluid flowing through the fluid outlet 18 and the firefighting hoseline 82. These data may be rendered to the user via one or more visual display devices provided on the control device 32.

The system controller 30 may also be configured to control one or more of the other actuated valve assemblies 84, 88, 92, 96, 98 used in the portable fluid pump 10, the electric motor operating the hose reel and/or lights attached to the portable fluid pump 10. In further examples, a plurality of system configurations may be stored on a storage device that is coupled to the system controller 30. Each of the system configurations may define one or more operational settings and/or target operational conditions for the portable fluid pump 10. When a particular system configuration is selected using the control device 32, the system controller 30 may cause the relevant controlled component(s) of the portable fluid pump 10 to operate in accordance with the selected configuration. For example, one or more of the system configurations may define a preset target fluid flow and a preset target pressure value for the fluid outlet 18 that the system controller 30 will operate to attain (and sustain) using the PID control loop.

The system controller 30 may also be programmed to execute shutdown procedures when certain prescribed operating conditions are encountered. For example, the system controller 30 may be programmed to stop the portable fluid pump 10 from operating when the fluid in the tank 12 has emptied or fallen below a minimum fluid capacity measure using sensors provided in the tank 12. In another example, the system controller 30 may be programmed to shut off the value 92 when the tank 12 has been filled to its maximum capacity when being replenished from an external fluid source 90.

The system controller 30 may comprise any device that is capable of executing instructions encoding arithmetic, logical and/or I/O operations and may include a microprocessor, central processing unit (CPU), microcontroller, programmable logic controller (PLC) and/or programmable logic array (PLA). The storage device may be integral with the system controller 90 or externally connected to the system controller 90. The storage device may comprise a volatile or non-volatile storage device, such as RAM, ROM, EEPROM or any other device capable of storing data. The remote control device 32 may send and receive control signals to and from the system controller 90 via a wired or wireless communication means.

The portable fluid pump 10 may also comprise various sensors (not shown) that measure operational characteristics of the portable fluid pump 10 and its components during use. These measurements may include, for example, the rotational speed of the electric motor(s) 20 and the throttle position settings of the actuated valve assemblies during use. The system controller 30 may also be configured to execute one or more maintenance routines recorded on the storage device. During each maintenance routine, various components of the portable fluid pump 10 may be caused to operate in accordance with certain test parameters and settings and the system controller 30 may evaluate the performance of each component.

The portable fluid pump 10 may also comprise a transmitter, such as a radio frequency transmitter, Wi-Fi, Bluetooth, NFC or cellular transmitter device (not shown), in communication with the system controller 30. The transmitter may send various data relating to the operation of the portable fluid pump 10 to a remote operating centre for real-time or offline analysis. This may include data collected using the sensors during normal operational runs of the portable fluid pump 10 and data embodying the results of maintenance routines executed by the system controller 30.

As depicted in FIG. 2, the portable fluid pump 10 may comprise a housing 100 that the various operational components of the portable fluid pump 10 are attached to or stored inside. The housing 100 advantageously provides that the portable fluid pump 10 is portable and may be mounted onto vehicles and trailers for transportation. The housing 100 may be made of lightweight aluminum sheeting and comprise one or more mounting assemblies configured such that the housing 100 may be detachably mounted onto a vehicle or trailer. In other examples, the mounting assemblies may enable the housing 100 to be permanently mounted onto a vehicle or trailer. The tank 12 may be made of polyurethane and be sealed inside of the housing 100 along with the pump 14, electric motors 20, batteries 74 and the system controller 30.

In use, the portable fluid pump 10 may be mounted onto vehicles and trailers and conveniently transported to locations where fluids need to be pumped at controlled pressures and flow rates. In the examples depicted in FIGS. 1 and 2, the portable fluid pump 10 is mounted on a firefighting vehicle that provides an effective portable fire-fighting system that may be used for a broad variety of situations and across different sectors and industries. This includes emergency services, mining, oil and gas, land management and bushfire mitigation. The positive displacement pump 14 included in the portable fluid pump 10 far exceeds the capabilities of centrifugal-type pumps that are commonly used in portable fire-fighting systems. The pump 14 and electric motor(s) 20 advantageously provide for improved operational efficiencies and generate substantially less noise than centrifugal pump systems.

It will be appreciated that positive displacement pumps provide maximum operating pressure regardless of the speed at which they are operating. Because the pressure sustaining control valve 24 reduces the net resultant pressure of the fluid pumped through the fluid outlet 18, this configuration advantageously decouples flow rate and pressure in the resultant fluid pumped through the fluid outlet 18 and the connected firefighting equipment. This enables the portable fluid pump 10 to pump fluid selectively at various different flow rate/pressure combinations, including high flow/low pressure, low flow/high pressure, high flow/high pressure and low flow/low pressure. In the examples depicted in FIGS. 3A-C and 4, the pump 14 comprises a single helical rotor pump but it will be understood that alternative positive displacement pumps and pump configurations may be used. For example, the pump 14 may comprise a screw pump comprising multiple screws that urge fluid along an elongate stator. In other examples, the portable fluid pump 10 may comprise two separate positive displacement pumps that may be arranged in parallel (to provide double the maximum output fluid flow rate) or in series (to provide double the maximum output pressure).

The valve assemblies included in the pump 10 may be controlled using electrically controlled solenoid actuators. This advantageously eliminates the need for human operators to turn valves on and off manually, as is commonly required in current portable fire-fighting systems. The configuration also reduces the potential for injury and harm and provides for an easy-to-use and operationally efficient system. Further, in examples where the hose reel is electronically operated, the need for manual handling of the firefighting hose is eliminated which, in turn, reduces the potential for strain injuries and fatigue over prolonged use.

Draughting of water from external water sources is also simple to achieve using the portable fluid pump 10. In prior art systems that use centrifugal-type pumps, the pumps must be primed with water using manually operated priming valves or electrically operated priming pumps before water can be drawn into the tank from the open water source. The positive displacement pump 14 used in the present invention advantageously eliminates the need for such priming mechanisms.

For the purpose of this specification, the word “comprising” means “including but not limited to”, and the word “comprises” has a corresponding meaning. Likewise, the words “preferably”, including variations such as “preferred”, and “may” will be understood to imply that a stated integer or group of integers is desirable but not essential to the working of the invention.

The above embodiments have been described by way of example only and modifications are possible within the scope of the claims that follow.

1. A portable fluid pump adapted to be mounted onto a vehicle or trailer, the portable fluid pump comprising:
a tank for storing fluid;
a positive displacement pump comprising a fluid inlet and a fluid outlet, wherein the fluid inlet is connected to the tank to receive the fluid from the tank, and wherein the positive displacement pump is configured to pump the fluid out of the fluid outlet and through a hoseline connected to the fluid outlet to be expelled onto a fire;
at least one electric motor that operatively drives the positive displacement pump, wherein the electric motor is a brushless variable speed electric motor configured to operate at 110 volts or less;
a conduit configured to divert fluid pumped by the positive displacement pump back into the tank, wherein the conduit is provided with an actuated valve assembly adapted to vary a flow rate of the proportion of the fluid diverted through the conduit and, therefore, vary a resultant pressure of fluid pumped through the hoseline by the positive displacement pump;
a pair of sensors configured to measure, respectively, a pressure and a flow rate of the fluid pumped through the hoseline by the positive displacement pump;
a system controller operatively connected to the electric motor, to the actuated valve assembly, to the sensors and to a control device, wherein the system controller is configured to:
receive from the control device a target fluid pressure and a target fluid flow rate for the fluid pumped through the hoseline; and
adjust a throttle position of the actuated valve assembly and a rotational speed of the electric motor to adjust independently, respectively, the resultant pressure and the flow rate of the fluid pumped through the hoseline such that pressure and flow rate readings received by the system controller from the sensors substantially match, respectively, the target fluid pressure and the target fluid flow rate.

2. The portable fluid pump according to claim 1, wherein the portable fluid pump comprises an outlet pump housing that receives pressurised fluid from the positive displacement pump, wherein the outlet pump housing comprises the fluid outlet and a second fluid outlet, the conduit being fluidly connected to the second fluid outlet.

3. The portable fluid pump according to claim 1, wherein the portable fluid pump comprises a fluid line connected to the fluid outlet, and wherein the conduit is fluidly connected to the fluid line.

4. The portable fluid pump according to claim 1, wherein the system controller executes a proportional-integral-derivative control loop to adjust the throttle position of the actuated valve assembly and the rotational speed of the electric motor.

5. The portable fluid pump according to claim 1, wherein a throttle of the actuated valve assembly is controlled by a solenoid actuator.

6. The portable fluid pump according to claim 1, wherein the actuated valve assembly comprises a butterfly valve.

7. The portable fluid pump according to claim 1, wherein the electric motor is a permanent magnet DC electric motor.

8. The portable fluid pump according to claim 1, wherein the electric motor comprises a gearing mechanism to increase an output torque of the electric motor.

9. The portable fluid pump according to claim 1, wherein the positive displacement pump is operatively driven by a drive belt, wherein the drive belt is connected to a drive pulley wheel axially connected to a drive shaft of the electric motor and to a driven pulley wheel axially connected to a drive shaft of the positive displacement pump, wherein a diameter of the drive pulley wheel is less than a diameter of the driven pulley wheel.

10. The portable fluid pump according to claim 9, wherein the portable fluid pump comprises a plurality of electric motors that drive the drive belt.

11. The portable fluid pump according to claim 10, wherein the portable fluid pump comprises an idler pulley wheel that engages the drive belt and a biaser mechanism configured to cause the idler pulley wheel to exert a force on the drive belt to maintain tension in the drive belt.

12. The portable fluid pump according to claim 10, wherein the plurality of electric motors are operatively connected to the driven pulley wheel by a pair of drive belts.

13. The portable fluid pump according to claim 1, wherein the positive displacement pump comprises a helical rotor pump.

14. The portable fluid pump according to claim 1, wherein the portable fluid pump further comprises one or more batteries for supplying an electric current to the electric motor, wherein the batteries are electrically connectable to an external power source to charge the batteries.

15. The portable fluid pump according to claim 14, wherein the portable fluid pump further comprises a step-up transformer connected between the batteries and the electric motor for increasing a voltage of the electric current.

16. The portable fluid pump according to claim 1, wherein the portable fluid pump further comprises:
a deluge system comprising one or more fluid dispensers fluidly connected to the fluid outlet for spraying fluid over the portable fluid pump; and
a valve assembly configured to control fluid flow from the fluid outlet to the deluge system.

17. The portable fluid pump according to claim 1, wherein the fluid inlet of the positive displacement pump is connectable to an external fluid source separate to the tank.

18. The portable fluid pump according to claim 1, wherein the tank further comprises a fluid inlet connectable to an external fluid source separate to the tank.

19. The portable fluid pump according to claim 1, wherein the system controller is provided with a storage device to store a plurality of system configurations, and wherein the system controller is configured to:
receive at least one of the system configurations selected by a user of the portable fluid pump using the control device;
determine a preset fluid pressure and a preset fluid flow rate associated with the at least one of the system configurations selected by the user; and
adjust a throttle position of the actuated valve assembly and a rotational speed of the electric motor to adjust, respectively, the resultant pressure and the flow rate of the fluid pumped through the hoseline such that the pressure and flow rate readings received by the system controller from the sensors substantially match, respectively, the preset fluid pressure and the preset fluid flow rate.

20. The portable fluid pump according to claim 1, wherein the control device is attached to a handheld firefighting nozzle at an end of the hoseline.
